(19) United States
(12) Patent Application Publication
(10) Pub. No.: US 2014/0272895 A1
(43) Pub. Date: Sep. 18, 2014

(54) COLLABORATIVE LEARNING ENVIRONMENT

(71) Applicant: TeachNow Inc., Washington, DC (US)

(72) Inventors: Emily Feistritzer, Washington, DC (US); Kunali Sanghvi, Mumbai (IN)

(73) Assignee: TeachNow Inc., Washington, DC (US)

(21) Appl. No.: 14/215,374

(22) Filed: Mar. 17, 2014

Related U.S. Application Data
(60) Provisional application No. 61/801,047, filed on Mar. 15, 2013.

(51) Int. Cl. G09B 5/08

(52) U.S. Cl. CPC G09B 5/08
USPC 434/350

(57) ABSTRACT

A collaborative learning environment receives an assignment from a first student user identity. In response to receiving the data representing the submission of the assignment, the collaborative learning environment sends a notification that the first student user identity has submitted the assignment to a plurality of student user identities and an instructor user identity, and makes the assignment and a comment module associated with the assignment accessible to the plurality of student user identities and the instructor user identity. The collaborative learning environment receives a comment from a second student user identity in the comment module. The collaborative learning environment receives data representing an evaluation of the assignment from the instructor user identity. After receiving the data representing the evaluation of the assignment, the collaborative learning environment sends the data representing the evaluation of the assignment to the first student user identity and to the second student user identity.

### CROSS REFERENCE TO RELATED APPLICATIONS

This application claims the benefit of the filing date of U.S. Provisional Application No. 61/801,047, which was filed on Mar. 15, 2013. The contents of U.S. Application No. 61/801,047 are incorporated by reference in their entirety as part of this application.

### TECHNICAL FIELD

This specification relates to an electronic collaborative learning environment.

### BACKGROUND

In certain circumstances, computer based courses are implemented using a lecture based teaching model. For example, computer based courses may provide a student with recorded lectures, and evaluate the student using computer based quizzes and exams. As such, such courses may lack the collaborative and social aspects that are important for a skills and research based curriculum.

### SUMMARY

In one aspect, a collaborative learning environment is executed by one or more processors. The collaborative learning environment receives data representing a submission of an assignment from a first student user identity, where the first student user identity is a member of an online class including a plurality of other student user identities and an instructor user identity. In response to receiving the data representing the submission of the assignment, the collaborative learning environment sends a notification that the first student user identity has submitted the assignment to the plurality of other student user identities and the instructor user identity, and makes the assignment and a comment module associated with the assignment accessible to the plurality of other student user identities and the instructor user identity. The collaborative learning environment receives a comment from a second student user identity in the comment module. The collaborative learning environment receives, from the instructor user identity, data representing an evaluation of the assignment. Lastly, in response to receiving the data representing the evaluation of the assignment, the collaborative learning environment sends the data representing the evaluation of the assignment to the first student user identity and to the second student user identity.

Implementations can include one or more of the following features. For example, sending the notification that the first student user identity has submitted the assignment to the plurality of other student user identities and the instructor user identity may include sending one or more of: a post on a collaborative learning environment homepage, an electronic mail message, a text message, or a social network to the plurality of other student user identities and the instructor user identity as a notification that the first student user identity has submitted the assignment.

The collaborative learning environment may update a progress chart associated with the first students user identity in response to receiving the data representing the submission of the assignment. In response to receiving the comment from the second student user identity in the comment module, the collaborative learning environment may store an indication that the second user identity has provided a comment in association participation data for the second user identity. The indication that the second user identity has provided a comment may include a snippet of the comment that the second user identity provided. The second student user identity may be designated by the instructor user identity to provide evaluation of the first student user identity's assignment.

The collaborative learning environment may receive a comment from a third student user identity in the comment module, and in response to receiving the data representing the evaluation of the assignment, the collaborative learning environment may send, the data representing the evaluation of the assignment to the first student user identity, the second student user identity, and the third student user identity.

In addition, the collaborative learning environment may receive data representing a resubmission of the assignment from the first student user identity. In response to receiving the data representing the resubmission of the assignment, the collaborative learning environment may send a notification that the first student user identity has resubmitted the assignment to the plurality of other student user identities and the instructor user identity, and make the resubmitted assignment and the comment module associated with the resubmitted assignment accessible to the plurality of other student user identities and the instructor user identity. The collaborative learning environment then may receive a comment on the resubmitted assignment from the second student user identity in the comment module. The collaborative learning environment may receive data representing an evaluation of the resubmitted assignment from the instructor user identity. Lastly, in response to receiving the data representing the evaluation of the resubmitted assignment, the collaborative learning environment may send the data representing the evaluation of the resubmitted assignment to the first student user identity and to the second student user identity.

The details of one or more implementation of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a swim lane diagram illustrating an exemplary activity submission process for an example electronic collaborative learning environment.

FIGS. 2A-2D show example graphical user interfaces (GUIs) of the example electronic collaborative learning environment.

FIG. 3 shows an example participation report.

FIG. 4 shows an example of a system that provides communications among an example electronic collaborative learning environment and various computing devices.

FIG. 5 is a flow chart of a process for activity submission in the example electronic collaborative learning environment.

Like reference symbols in the various drawings indicate like elements.

### DETAILED DESCRIPTION

An electronic collaborative learning environment may facilitate a more collaborative learning environment conducive to a skills-based or research-based curriculum. The electronic collaborative learning environment may allow students to submit projects and receive feedback from both instructors and other students, and to use the provided feedback to revise the submitted project prior to a final due date. Furthermore, the electronic collaborative learning environment is adaptable to various learning models, and is particularly conducive to a project based, collaborative learning model. For example, it may be aptly used to implement a non-traditional, collaborative learning model such as one in which the instructor serves as a facilitator of learning instead of the source of knowledge.

An electronic collaborative learning environment also may be adapted to different curricula, and is particularly tailored to a skills or research focused curriculum. For example, the electronic collaborative learning environment may be tailored to a teacher certification curriculum focused on equipping candidates to walk into any learning environment and diagnose where each learner is and to design instructional and learning experiences to move the learner from their current position of knowledge and skills to a desired position of knowledge and skills. Moreover, in support of a skills focused curriculum, the electronic collaborative learning environment is particularly adapted to smaller class, or cohort, sizes (e.g. twelve students to one instructor and one or more mentors), and to group and clinical activities. An electronic collaborative learning environment curriculum may be, for example, organized into several modules, each module including several units, and each unit requiring a candidate to perform several activities.

The term candidate is used herein to describe a student participating in an electronic collaborative learning environment curriculum.

The term cohort is used herein to describe the members of an electronic collaborative learning environment class and includes several candidates, one or more instructors, and, optionally, one or more candidate mentors. A cohort may differ from a traditional class in that the electronic collaborative learning environment is designed to facilitate curricula focused on more peer-to-peer collaborative learning than traditional instructor lead classes. The electronic collaborative learning environment may allow an instructor to serve more as a facilitator of learning rather than as one who imparts knowledge, thus guiding candidates to learn by research and from each other.

An example electronic collaborative learning environment is an electronic platform that facilitates discussion amongst members of an electronic collaborative learning environment class (e.g., a cohort), submission of activities (e.g., assignments), commenting on and peer review of submitted activities, revision of activities, and evaluation and final feedback on submitted activities. An electronic collaborative learning environment cohort may include several student user identities and an instructor user identity. Student and instructor user identities may be electronic profiles for human candidates and instructors. The user identities correspond with user accounts associated with each candidate and instructors. Each user account reflects various different types of information about or otherwise related to the associated candidates' and instructors' use of the electronic collaborative learning environment. For example, information related to a student user identity may include a candidate's progress in an electronic collaborative learning environment curriculum, a schedule of tasks and activities to be completed, and evaluations of the candidate's performance. Similarly, information related to an instructor user identity may include a data related to various cohorts that the instructor is guiding or instructing. In addition, candidate and instructor user identities may have differing levels of access privileges to tools, features, and data within the electronic collaborative learning environment. For example, student user identities may not be provided access to various administrative and activity evaluation features.

The electronic collaborative learning environment implements an activity based learning curriculum. For example, the electronic collaborative learning environment facilitates the assignment of various activities to a cohort of candidates. The activities may be group activities, clinical activities, or technology based activities such as video annotation activities, blog posts, reflection notes or file/link upload activities, and each activity may be aligned with an objective-oriented specific learning process. After the completion of an activity each candidate may be required to submit a deliverable (e.g., a document, spreadsheet, presentation, video file, clinical evaluation, etc.) before a submission deadline or activity closing date using the candidate's student user identity.

The electronic collaborative learning environment receives a submitted activity deliverable from a specific candidate's student user identity (e.g., candidate A), and sends a notification of the submitted assignment deliverable to the instructor's user identity and the student user identities of other candidates within the cohort. In addition, the electronic collaborative learning environment may make the submitted activity deliverable and a comment module accessible to the instructor's user identity and the student user identities of the other candidates in the cohort. The comment module allows the other candidates within the cohort as well as the instructor to comment on Candidate A's work, thereby facilitating collaboration.

When another student user identity (e.g., candidate B) comments on candidate A's submitted activity deliverable the electronic collaborative learning environment sends a notification to some or all of the members of the cohort. In addition, the electronic collaborative learning environment may store data indicating that candidate B's has commented on candidate A's work. In addition, the data indicating the candidate B has commented on candidate A's work and/or the comment may be incorporated into a participation score for candidate B. Once the instructor submits an evaluation of candidate A's proficiency level for the given activity based on candidate A's activity deliverable, the electronic collaborative learning environment may send an evaluation notification not only to candidate A's student user identity, but also to candidate B's because candidate B commented on candidate A's activity deliverable. The evaluation notification may both alert candidates A and B that the instructor has evaluated candidate A's submitted activity deliverable and provide both candidates A and B with access to data related to the evaluation (.e.g., a proficiency level attained by candidate A on the activity and/or remarks from the instructor).

In addition, the electronic collaborative learning environment may allow a candidate who has submitted an activity deliverable to revise and resubmit the activity deliverable taking into consideration comments received from other candidates, the instructors, and/or a candidate mentor. The above described process of activity deliverable submission and commenting may continue until a final activity closing date, at which time additional submissions related to a specific activity may no longer be permitted and after which the instructor will evaluate submitted activity deliverables. The electronic collaborative learning environment may send evaluation notifications to each candidate once the instructor evaluates each specific candidate's activity deliverable and to any or all candidates who have commented on the specific evaluated activity deliverable. For instance, once the instructor submits an evaluation for candidate A's activity deliverable for activity 1, the electronic collaborative learning environment may send notifications that candidate A's activity 1 activity deliverable has been evaluated not only to candidate A, but also to any other candidates who commented on candidate A's activity deliverable for activity 1. Alternatively or in addition, the electronic collaborative learning environment may send evaluation notifications to all candidates in a cohort or only to a subset of all the candidates who provided comments (e.g., candidates designated by the instructor as peer-reviewers for candidate A's work).

FIG. 1 and FIGS. 2A-2D illustrate the process described above in more detail. FIG. 1 is a swim lane diagram illustrating an exemplary activity submission process 100 for an example electronic collaborative learning environment. The process 100 illustrates interactions between the electronic collaborative learning environment 104 and user identities for student A 102, an Instructor 106, student B 108, and student C 110 for an example activity 1. For clarity, the creation of blog post will be used as an example activity 1 and the blog post will be used as an example activity deliverable for activity 1. FIG. 1 is described in relation to FIGS. 2A-2D which show example graphical user interfaces (GUIs) of the example electronic collaborative learning environment 104.

Referring to FIG. 2A, upon logging into electronic collaborative learning environment 104, student user identity A 102 may be presented with a home page such as GUI 200 of FIG. 2A. GUI 200 includes a candidate information panel 202, a progress panel 204, and a performance panel 206. The candidate information panel 202 includes candidate profile information 208, for example, a name and photograph of the candidate, and information related to the candidate's study curriculum 210 in the electronic collaborative learning environment (e.g., a syllabus or a link to a syllabus).

The progress panel 204 includes a progress chart 212 and a program schedule 214. The progress chart 212 may show the candidate's progress through an entire curriculum or a section of the curriculum (e.g., a module). For example, the progress chart 212 is a pie chart depicting a candidate's progress through a module of the Teach Now teacher training curriculum. The progress chart 212 shows the candidate the number of activities (e.g., assignments) that the candidate has completed, has submitted but that are not yet evaluated by an instructor, has in progress, has not started, and has missed the deadline.

The performance panel 206 includes a performance chart 216, an announcements widget 218, and a chat widget 220. The performance chart 216 may show the candidate's progress through an entire curriculum or a section of the curriculum (e.g., a module). For example, the performance chart 216 is a bar graph depicting a candidate's performance on several activities in a module of the Teach Now teacher training curriculum. The announcements widget 218 may display recent announcements pertaining to the candidate. Finally, the chat widget 219 may allow the candidate to conduct real-time text discussions with other candidates (e.g., students) or instructors.

Referring now to FIG. 2B, in order to begin activity 1, student user identity A 102 may access a learn page, such as GUI 220 of FIG. 2B, by selecting a learn tab 222. GUI 220 is an example electronic collaborative learning environment learn page. GUI 220 includes a progress summary panel 224, a schedule panel 226, and a collaboration panel 228. The progress summary panel 224 includes charts 230, and a table of contents 232 for the curriculum, the module, or both. Charts 230 depict the candidate's progress though the curriculum or a module of the curriculum and an indication of the candidate's present performance on tasks in the curriculum or the module.

The schedule panel 226 includes a schedule widget 234 and notification widgets (236a and 236b). The schedule widget 234 provides a candidate with a list of upcoming events and activities deadlines. The notification widgets 236a and 236b display notifications generated by electronic collaborative learning environment 104. Notification widget 236a may, for example, display notifications related to activity submission deadlines and curriculum events, while notification widget 236b may display notifications generated by electronic collaborative learning environment 104 based on various interactions by user identities (e.g., user identities 102, 106, 108, or 110) with electronic collaborative learning environment 104.

The collaboration panel 228 includes several collaboration widgets 238a-238d. Collaboration widget 238a is an instructor contact widget. Widget 238a may provide a convenient way for candidate to send a message (e.g., a chat message, an E-mail, a text message, etc.) to an instructor. Widget 238b may provide links to one or more virtual classrooms using, for example, an internet collaboration tool such as Adobe Connect or WebEx. Widget 238c may provide links to existing discussion forums related to various activities or topics, and a selection button to generate new discussion forum threads. Lastly, widget 238d may be a chat widget to allow a candidate to send chat messages to other candidates' student user identities and/or instructors' instructor user identities.

Referring back to FIG. 1, electronic collaborative learning environment 104 receives a submission of an activity deliverable from student user identity A 102 (112). Student user identity A 102 may submit a blog post, for example, through an example activity page GUI 240 as shown in FIG. 2C. Referring to FIG. 2C, activity page GUI 240 provides student user identity A 102 with a description of an activity and instructions for completing the activity, and GUI 240 includes a references widget 242 and an activity submission module 244. References widget 242 may include links to various reference sources (e.g., instructional documents, websites, internet videos, etc.) related to the completion of an activity associated with GUI 240.

Activity submission module 244 allows student user identity A 102 to submit an activity deliverable (e.g., a blog post) for activity 1. Activity deliverables for other activities may include, for example, a document, spreadsheet, presentation, video, etc. Activity submission module 244 may allow student user identity A 102 to generate an activity deliverable directly for activity 1 within GUI 240 (e.g., student user identity A 102 may generate the blog post using a text entry module as shown in FIG. 2C). In addition or alternatively, activity submission module 244 may allow student user identity A 102 to select an upload an activity deliverable contained in a computer file (e.g., a document, spreadsheet, presentation, or video file).

After electronic collaborative learning environment 104 receives student user identity A's 102 activity deliverable for activity 1, electronic collaborative learning environment 104 may send an activity submission notification to instructor user identity 106, student user identity B 108, and student user identity C 110 (114). Activity submission notifications may be sent to instructor user identity 106, student user identity B 108, and student user identity C 110 as notification messages sent to notification widgets 236a or 236b, text messages or E-mail messages. In addition, electronic collaborative learning environment 104 may make student user identity A's 102 activity deliverable for activity 1 accessible to each user identity that receives a notification and generate a comment module associated with student user identity A's 102 activity deliverable for activity 1 (e.g., comment from 250 shown in FIG. 2D). Each student user identity's activity deliverable for each activity in a curriculum may be associated with an individual comment module. In addition or alternatively, electronic collaborative learning environment 104 may generate an activity wide comment module associated with all (or a subset of all) of the activity deliverables submitted by each of student user identity in a cohort for a specific activity or type of activity (e.g., group activities). Electronic collaborative learning environment 104 may provide the instructor user identity 106, student user identity B 108, and student user identity C 110 with access to student user identity A's 102 activity deliverable via a hyperlink in the activity submission notification, for example.

Referring to FIGS. 1 and 2D, electronic collaborative learning environment 104 receives a comment from student user identity B 108 (116). For example, student user identity B may submit a comment related to student user identity A's 102 activity deliverable for activity 1 by entering the comment in text entry box 252 of the comment module 250 and selecting selection button 254. Electronic collaborative learning environment 104 may generate comment module 250 within student user identity A's 102 activity page GUI 240 for activity 1 after electronic collaborative learning environment 104 receives student user identity A's 102 activity deliverable for activity 1 (112).

Referring back to FIG. 1, upon receiving student user identity B's 108 comment, electronic collaborative learning environment may send a comment notification to instructor user identity 106, student user identity A 102, and student user identity C 110 (116). Comment notifications may be sent to instructor user identity 106, student user identity A 104, and student user identity C 110 as notification messages sent to notification widgets 236a or 236b, text messages or E-mail messages. In addition, the comment notification may include all of or a portion of (e.g., a snippet) student user identity B's 108 comment. Additionally or alternatively, the comment notification may contain a hyperlink to student user identity B's 108 comment.

In some implementations or for some activities, electronic collaborative learning environment 104 may allow student user identity A 102 to resubmit a modified version of student user identity A's 102 activity 1 activity deliverable. For instance, a candidate associated with student user identity A may wish to make revisions based on comment received from other candidates (i.e., from other candidates' student user identities) or from an instructor (i.e., from the instructor's user identity). In such implementations or for such activities, electronic collaborative learning environment 104 may receive student user identity A's 102 resubmitted activity deliverable for activity 1 (120), for example, via activity submission module 244 of GUI 240 as described above.

Upon receipt of student user identity A's 102 revised activity deliverable for activity 1, electronic collaborative learning environment 104 may, send an activity resubmission notification to instructor user identity 106, student user identity B 108, and student user identity C 110 (122). Activity resubmission notifications may be sent to instructor user identity 106, student user identity B 108, and student user identity C 110 as notification messages sent to notification widgets 236a or 236b, text messages or E-mail messages. In addition, electronic collaborative learning environment 104 may make student user identity A's 102 revised activity deliverable for activity 1 accessible to each user identity that receives a notification. Electronic collaborative learning environment 104 may provide the instructor user identity 106, student user identity B 108, and student user identity C 110 with access to student user identity A's 102 revised activity deliverable via a hyperlink in the activity resubmission notification, for example. Electronic collaborative learning environment 104 may allow student user identity A to revise and resubmit activity deliverable for activity 1 as often as desired until the expiration of an activity closure deadline.

In some implementations or for some activities, electronic collaborative learning environment 104 may send resubmission notifications only to the instructor user identity 106 and to those student user identities that previously submitted comments on student user identity A's 102 original activity deliverable for activity 1. For instance, in the example shown in FIG. 1, in such implementations or for such activities, electronic collaborative learning environment 104 may only send activity resubmission notifications to instructor user identity 106 and student user identity B 108, but not to student user identity C 110 because student user identity C did not comment on student user identity A's 102 original activity deliverable for activity 1.

In addition, a new comment module 250 need not be generated to receive comments related to the student user identity A's 102 revised activity 1 activity deliverable. The comment module 250 generated in response to receiving student user identity A's original activity deliverable for activity 1 may be used to receive comments related to the revised activity 1 activity deliverable.

After the expiration of an activity closure deadline, electronic collaborative learning environment 104 may receive an evaluation of student user identity A's 102 activity deliverable for activity 1 from instructor user identity 106 (124). The evaluation may include a proficiency level that the instructor believes the candidate associated with student user identity A 102 has achieved in addition to feedback on the activity deliverable and associated revisions.

In response to receiving the evaluation from instructor user identity 106, electronic collaborative learning environment 104 may send evaluation notifications to student user identities A 102 and B 108. Activity evaluation notifications may be sent to student user identity A 102 and student user identity B 108 as notification messages sent to notification widgets 236a or 236b, text messages, or E-mail messages. Electronic collaborative learning environment 104 may not send an evaluation notification to student user identity C 110 because student user identity C 110 did not submit any comments on student user identity A's 102 activity deliverable. Thus, in addition to the student user identity who's activity deliverable has been evaluated, electronic collaborative learning environment 104 may send evaluation notifications to only those student user identities who have submitted comments on that student user identity's activity deliverable. However, in some implementations or for some activities, electronic collaborative learning environment 104 may send activity evaluation notifications to all of the student user identities in a cohort regardless of whether they have submitted comments.

In some implementations or for some activities, electronic collaborative learning environment 104 may allow the instructor user identity 106 to designate one or more specific student user identities (e.g., specific candidates) to provide comments on another student user identity's activity deliverable (e.g., an instructor may assign specific candidates to provide a detailed peer review of each other's work). In implementations or for such activities, electronic collaborative learning environment 104 may only sent applicable notifications to such designated student identities in addition to the student identity submitting the applicable activity deliverable.

In some implementations, when a student user identity (e.g., student user identity B 108) submits a comment on another student user identity's (e.g., student user identity A 102) activity deliverable electronic collaborative learning environment 104 may store comment data indicating that the commenting student user identity (e.g., e.g., student user identity B 108) has submitted a comment. The comment data may include the submitted comment, a portion of the submitted comment (e.g., a snippet), and/or a link to the submitted comment. In addition the comment data may be stored in association with participation data for to the commenting student user identity (e.g., e.g., student user identity B 108). As described below in conjunction with FIG. 3, the comment data may be incorporated into a participation report for the commenting student user identity (e.g., e.g., student user identity B 108).

In some implementations, electronic collaborative learning environment 104 may update a progress chart (e.g., progress chart 212 of FIG. 2A) for a student user identity in response to receiving for the student user identity any or all of: an activity deliverable submission, a comment, an activity deliverable resubmission, or an activity evaluation.

FIG. 3 shows an example participation report 300. The electronic collaborative learning environment may generate participation report 300 based on stored participation data related to a specific student user identity (e.g., Candidate A). As described above, participation data my include data related to various comments that the specific student user identity has provided to other student user identities. In addition, the participation data may include data related to discussion posts and peer reviews (e.g., comments made by the specific student user identity when designated by the instructor user identity as a peer reviewer for another student user identity). The participation data may include, the number of participation submissions (e.g., comments, discussion posts, or peer reviews) made by the specific student user identity, the student user identity to which a participation submission was directed, the activity with which a submission was associated, and the full text of the participation submission or a portion of the text (e.g., a snippet of the text).

The participation report 300 includes a student user identity selection menu 302, a participation data chart 304, and a data viewing window 306. The participation data chart 304 summarizes all of the participation data stored for the selected student user identity for each module in an electronic collaborative learning environment curriculum. The participation data chart 304 shows the number of comments, discussion posts, and peer reviews that the selected student user identity submitted for activities in each listed module. In addition, the data listed in the participation data chart 304 may include hyperlinks to data viewing windows. For example, when the “2” peer reviews for module 2 is selected by a user the electronic collaborative learning environment may generate data viewing window 306 to be displayed. Data viewing window 306 may be scrollable to and may show more detailed data related to each peer review submitted by candidate A during module 2, for example. Data viewing window 306 may display the type of participation submission (e.g., Peer Review), the student user identity to whom the participation submission was directed (e.g., candidate B), and the text of the participation submission or a snippet of the text. Instructors may use the data displayed in participation reports 300 to aid in determining a participation score for candidates.

In some implementations, instructor user identities may be permitted to rate student user identity participation submissions in “real-time” during an activity as the instructor reviews the submitted participation submissions from various student user identities. For example, as an instructor is reading comments submitted by student user identity A for activity 1 of module 1, the instructor may think that the comment was extremely insightful, and thus, may be allowed to rate that comment highly, for example, a 4 on a 0-4 scale. The instructor's rankings may be stored with the comment data for student user identity A's comment for activity 1 of module 1, and may be displayed in data viewing window 306.

In some implementations, the electronic collaborative learning environment may incorporate textual analysis analytics (e.g., a textual analysis engine, such as, Lexalytics) to determine whether participation submissions are generally positive or negative. Such analysis may be used to generate a weighted average of the participation submissions submitted by a student user identity, which may serve as a recommended participation score for the student user identity.

In some implementations, the participation report 300 may also include a cohort selection menu, for example, to allow an administrator to view data related to candidates in various different cohorts.

FIG. 4 shows an example of a system 400 that provides communications among an example electronic collaborative learning environment and various computing devices. The system 400 may be used to perform the process 100 described above in relation to FIG. 1. For illustrative purposes, several elements illustrated in FIG. 4 and described below are represented as monolithic entities. However, these elements each may include and/or be implemented on numerous interconnected computing devices and other components that are designed to perform a set of specified operations.

As illustrated in FIG. 4, system 400 includes a computing system 402 that hosts an electronic collaborative learning environment 402 that is accessible to a number of computing devices 404(a)-404(n) and 406, including, for example, a desktop computer, a laptop computer, a tablet computer, and a smartphone, over a network 408. Computing system 402 may be accessible to computing devices 404(a)-404(n) and 406 over network 408 and may include one or more computing devices (e.g., servers) configured to provide a service to one or more client devices (e.g., computing devices 404(a)-404(n) and 406) over network 408. The computing system 402 on which the electronic collaborative learning environment is implemented may have internal or external storage components storing data and programs such as an operating system and one or more application programs. The electronic collaborative learning environment may be implemented as instructions that are stored in the storage components and that, when executed, cause the one or more computing devices to provide the features of an electronic collaborative learning environment. Furthermore, the computing system 402 on which the electronic collaborative learning environment is implemented each may include one or more processors for executing instructions stored in storage and/or received from one or more other electronic devices, for example over network 408. In addition, the computing system 402 also may include network interfaces and communication devices for sending and receiving data.

Computing devices 404(a)-404(n) and 406 may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 404(a)-404(n) and 406 typically may have internal or external storage components for storing data and programs such as an operating system and one or more application programs. In particular, the internal or external storage components for each of the computing devices 404(a)-404(n) and 406 may store a client application for interfacing with the electronic collaborative learning environment and/or computing system 402. Additionally or alternatively, computing devices 404(a)-404(n) and 406 may be configured to interface with electronic collaborative learning environment and/or computing system 402 without a specific client application, using, for example, a web browser.

Each of the computing devices 404(a)-404(n) and 406 also typically may include a central processing unit (CPU) for executing instructions stored in storage and/or received from one or more other electronic devices, for example over network 408. Each of the computing devices 404(a)-404(n), and 406 also usually may include one or more communication devices for sending and receiving data. One example of such communications devices is a modem. Other examples include antennas, transceivers, communications cards, and other network adapters capable of transmitting and receiving data over a network (e.g., network 408) through a wired or wireless data pathway.

Network 408 may provide direct or indirect communication links between computing system 402 and computing devices 404(a)-404(n), and 406. Examples of network 408 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

FIG. 5 is a flow chart of a process 500 for activity submission in the example electronic collaborative learning environment. The process 500 may be implemented by an electronic collaborative learning environment hosted by a computing system, such as, for example, computing system 402 of FIG. 4.

The electronic collaborative learning environment receives data representing a submission of an assignment from a first student user identity (510). The first student user identity may be a member of an online class (e.g., a cohort) including a plurality of other student user identities and an instructor user identity. The data representing the assignment may be an activity deliverable such as, for example, a blog post, a document, a spreadsheet, a presentation, a video file, or a clinical evaluation. In addition, the assignment by be received from a student user identity submission via an activity submission module (e.g., activity submission module 244 of GUI 240 in FIG. 2C).

In response to receiving the data representing the submission of the, the electronic collaborative learning environment sends a notification that the first student user identity has submitted the assignment to the plurality of other student user identities and the instructor user identity (220B). The notification may be a notification messages sent to a notification widget (e.g., notification widgets 236a or 236b of GUI 220 in FIG. 2B), a text message or an E-mail message.

In response to receiving the data representing the submission of the assignment, the electronic collaborative learning environment also makes the assignment and a comment module associated with the assignment accessible to the plurality of student user identities and the instructor user identity (220A). For instance, the notification may include a link to the submitted assignment and the comment module (e.g., a hyperlink). In addition or alternatively, the notification may include an attached computer file including the assignment submitted by the first user identity.

Next, the electronic collaborative learning environment receives a comment from a second student user identity in the comment module (530), for example, from comment module 250 shown in FIG. 2D. In addition, the electronic collaborative learning environment may store data related to the comment in association with participation data related to the second student user identity.

The electronic collaborative learning environment receives data representing an evaluation of the assignment from the instructor user identity (540). The evaluation may include a proficiency level that the instructor believes the first student has achieved in addition to feedback on assignment.

Finally, in response to receiving the data representing the evaluation of the assignment, electronic collaborative learning environment may send an evaluation notification to the first student user identity and to the second student user identity. The evaluation notification may be a notification messages sent to a notification widget (e.g., notification widgets 236a or 236b of GUI 220 in FIG. 2B), a text message or an E-mail message. In addition, the notification may include a link to the evaluation. In addition or alternatively, the notification may include the evaluation.

In some implementations or for some activities, steps 510-540 may be repeatable, for instance, to allow the first student user identity to submit revise and resubmit their assignment until an activity closing deadline. In such implementations or for such activities, the instructor user identity may only be permitted to submit an evaluation of the assignment after the activity closing deadline. In some implementations or for some activities, the instructor may be permitted to submit an evaluation of the assignment at any time after the assignment has been received from the first student user activity.

In some implementations, upon receiving a comment from a second student user identity, the electronic collaborative learning environment may send a comment notification to the instructor user identity, the first student user identity, and the plurality of other student user identities or a subset of the plurality of other student user identities (e.g., only those other student user identities who have also submitted a comment). The comment notification may be a notification messages sent to a notification widget (e.g., notification widgets 236a or 236b of GUI 220 in FIG. 2B), a text message or an E-mail message. In addition, the comment notification may include all of or a portion of (e.g., a snippet) the second student user identity's comment. Additionally or alternatively, the comment notification may contain a hyperlink to the second student user identity's comment.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A computer implemented method for a collaborative learning environment executed by one or more processors, the method comprising:
receiving data representing a submission of an assignment from a first student user identity, the first student user identity being a member of an online class including a plurality of other student user identities and an instructor user identity;
in response to receiving the data representing the submission of the assignment:
sending a notification that the first student user identity has submitted the assignment to the plurality of other student user identities and the instructor user identity, and
making accessible to the plurality of other student user identities and the instructor user identity, the assignment and a comment module associated with the assignment;
receiving, from a second student user identity, a comment in the comment module;
receiving, from the instructor user identity, data representing an evaluation of the assignment;
in response to receiving the data representing the evaluation of the assignment, sending, to the first student user identity and to the second student user identity, the data representing the evaluation of the assignment.

2. The method of claim 1, comprising in response to receiving the data representing the submission of the assignment, updating a progress chart associated with the first student user identity.

3. The method of claim 1, comprising in response to receiving, from the second student user identity, the comment in the comment module, storing in association participation data for the second user identity, an indication that the second user identity has provided a comment.

4. The method of claim 1, comprising receiving, from a third student user identity, a comment in the comment module, and
wherein in response to receiving the data representing the evaluation of the assignment, sending, to the first student user identity and to the second student user identity the data representing the evaluation of the assignment comprises in response to receiving the data representing the evaluation of the assignment, sending, to the first student user identity, to the second student user identity, and to the third student user identity the data representing the evaluation of the assignment.

5. The method of claim 1, comprising:
receiving, from the first student user identity, data representing a resubmission of the assignment;
in response to receiving the data representing the resubmission of the assignment:
sending a notification that the first student user identity has resubmitted the assignment to the plurality of other student user identities and the instructor user identity, and
making accessible to the plurality of other student user identities and the instructor user identity, the resubmitted assignment and the comment module associated with the resubmitted assignment;
receiving, from the second student user identity, a comment on the resubmitted assignment in the comment module;
receiving, from the instructor user identity, data representing an evaluation of the resubmitted assignment;
in response to receiving the data representing the evaluation of the resubmitted assignment, sending, to the first student user identity and to the second student user identity, the data representing the evaluation of the resubmitted assignment.

6. The method of claim 1, wherein the second student user identity is designated by the instructor user identity to provide evaluation of the first student user identity's assignment.

7. A system comprising:
one or more computers and one or more storage devices storing instructions that are operable, when executed by the one or more computers, to cause the one or more computers to perform operations comprising:
receiving data representing a submission of an assignment from a first student user identity, the first student user identity being a member of an online class including a plurality of other student user identities and an instructor user identity;
in response to receiving the data representing the submission of the assignment:
sending a notification that the first student user identity has submitted the assignment to the plurality of other student user identities and the instructor user identity, and
making accessible to the plurality of other student user identities and the instructor user identity, the assignment and a comment module associated with the assignment;
receiving, from a second student user identity, a comment in the comment module;
receiving, from the instructor user identity, data representing an evaluation of the assignment;
in response to receiving the data representing the evaluation of the assignment, sending, to the first student user identity and to the second student user identity, the data representing the evaluation of the assignment.

8. The system of claim 7, wherein the instructions comprise in response to receiving the data representing the submission of the assignment, updating a progress chart associated with the first student user identity.

9. The system of claim 7, wherein the instructions comprise in response to receiving, from the second student user identity, the comment in the comment module, storing in association participation data for the second user identity, an indication that the second user identity has provided a comment.

10. The system of claim 7, wherein the instructions comprise receiving, from a third student user identity, a comment in the comment module, and
wherein in response to receiving the data representing the evaluation of the assignment, sending, to the first student user identity and to the second student user identity the data representing the evaluation of the assignment comprises in response to receiving the data representing the evaluation of the assignment, sending, to the first student user identity, to the second student user identity, and to the third student user identity the data representing the evaluation of the assignment.

11. The system of claim 7, wherein the instructions comprise:
receiving, from the first student user identity, data representing a resubmission of the assignment;
in response to receiving the data representing the resubmission of the assignment:
sending a notification that the first student user identity has resubmitted the assignment to the plurality of other student user identities and the instructor user identity, and
making accessible to the plurality of other student user identities and the instructor user identity, the resubmitted assignment and the comment module associated with the resubmitted assignment;
receiving, from the second student user identity, a comment on the resubmitted assignment in the comment module;
receiving, from the instructor user identity, data representing an evaluation of the resubmitted assignment;
in response to receiving the data representing the evaluation of the resubmitted assignment, sending, to the first student user identity and to the second student user identity, the data representing the evaluation of the resubmitted assignment.

12. The system of claim 7, wherein the second student user identity is designated by the instructor user identity to provide evaluation of the first student user identity's assignment.

13. A non-transitory computer-readable medium storing software comprising instructions executable by one or more computers which, upon such execution, cause the one or more computers to perform operations comprising:
receiving data representing a submission of an assignment from a first student user identity, the first student user identity being a member of an online class including a plurality of other student user identities and an instructor user identity;
in response to receiving the data representing the submission of the assignment:
sending a notification that the first student user identity has submitted the assignment to the plurality of other student user identities and the instructor user identity, and
making accessible to the plurality of other student user identities and the instructor user identity, the assignment and a comment module associated with the assignment;
receiving, from a second student user identity, a comment in the comment module;
receiving, from the instructor user identity, data representing an evaluation of the assignment;
in response to receiving the data representing the evaluation of the assignment, sending, to the first student user identity and to the second student user identity, the data representing the evaluation of the assignment.

14. The non-transitory computer-readable medium of claim 13, wherein the instructions comprise in response to receiving the data representing the submission of the assignment, updating a progress chart associated with the first student user identity.

15. The non-transitory computer-readable medium of claim 13, wherein the instructions comprise in response to receiving, from the second student user identity, the comment in the comment module, storing in association participation data for the second user identity, an indication that the second user identity has provided a comment.

16. The non-transitory computer-readable medium of claim 13, wherein the instructions comprise:
receiving, from a third student user identity, a comment in the comment module, and
wherein in response to receiving the data representing the evaluation of the assignment, sending, to the first student user identity and to the second student user identity the data representing the evaluation of the assignment comprises in response to receiving the data representing the evaluation of the assignment, sending, to the first student user identity, to the second student user identity, and to the third student user identity the data representing the evaluation of the assignment.

17. The non-transitory computer-readable medium of claim 13, wherein the instructions comprise:
receiving, from the first student user identity, data representing a resubmission of the assignment;
in response to receiving the data representing the resubmission of the assignment:
sending a notification that the first student user identity has resubmitted the assignment to the plurality of other student user identities and the instructor user identity, and
making accessible to the plurality of other student user identities and the instructor user identity, the resubmitted assignment and the comment module associated with the resubmitted assignment;
receiving, from the second student user identity, a comment on the resubmitted assignment in the comment module;
receiving, from the instructor user identity, data representing an evaluation of the resubmitted assignment;
in response to receiving the data representing the evaluation of the resubmitted assignment, sending, to the first student user identity and to the second student user identity, the data representing the evaluation of the resubmitted assignment.

18. The non-transitory computer-readable medium of claim 13, wherein the second student user identity is designated by the instructor user identity to provide evaluation of the first student user identity's assignment
